(19) United States
(12) Patent Application Publication
(10) Pub. No.: US 2014/0115166 A1
(43) Pub. Date: Apr. 24, 2014

(54) SYSTEM, METHOD, AND APPARATUS FOR DETERMINING ALLOCATION OF FILTERING RESOURCES FOR THE FILTERING OF CAPTURED DATA PACKETS

(71) Applicant: VSS Monitoring, Inc., Sunnyvale, CA (US)

(72) Inventors: David Kucharczyk, Santa Fe, NM (US); Jan Allen Hinshaw, Prescott, AZ (US)

(73) Assignee: VSS Monitoring, Inc., Sunnyvale, CA (US)

(21) Appl. No.: 14/062,787

(22) Filed: Oct. 24, 2013

Related U.S. Application Data
(60) Provisional application No. 61/718,149, filed on Oct. 24, 2012.

(51) Int. Cl. H04L 29/06

(52) U.S. Cl. CPC H04L 63/0227
USPC 709/226

(57) ABSTRACT

A network filtering device receives an instruction to deploy filtering resources (e.g., of a filtering system, etc.) to filter captured network traffic in a communication network according to at least one criterion. Notably, the instruction is received from a user via an interface communicatively coupled to the filtering system. The network filtering device further analyzes the received instruction and projects, responsive to the analysis, an amount of filtering resources required to filter the captured traffic according to the received instruction. The network filtering device also provides the projected amount to the user via the interface.

### CROSS-REFERENCE TO RELATED APPLICATIONS

The present application claims priority of U.S. Provisional Patent Application Ser. No. 61/718,149, filed on Oct. 24, 2012, the content of which is herein incorporated by reference.

### BACKGROUND

1. Field of the Invention

The present disclosure relates to network usage monitoring, and more particularly, to visualizing resource utilization according to one or more filtering criterion.

2. Description of the Related Art

Communication networks, such as the Internet, corporate intranets, cellular communication networks, etc., are the chosen form of information distribution. A means for monitoring information distributed from such communication networks is of ever increasing importance as such communication networks become ever more ubiquitous. Network monitoring provides valuable information, statistical or otherwise, to network service providers, network users or network beneficiaries, such as network advertisers.

In the context of network monitoring, conventional approaches such as filtering and the like, involve inputting, for example, a desired filter expression to a network monitoring device. In turn, the network monitor device executes the desired filter expression via one or more additional network devices (e.g., capture devices, routing devices, etc.). However, depending on the network configuration, a simple filter expression, when executed, can result in unexpectedly large network monitoring resources. Excessively burdening network monitoring resources negatively impacts overall network monitoring and (in certain come instances) may even burden the underlying communication of information.

### SUMMARY

In one embodiment of the invention, a filtering system (e.g., a captured network traffic distribution device (e.g., a network tap or similar device) or a stacked network of captured network traffic distribution devices in communication with one another) may be configured to receive instructions to deploy filtering resources to filter captured data packets according to at least one criterion or parameter. The instructions may be analyzed and a projected amount of filtering resources required to filter the captured traffic according to the received instruction may be projected and then provided to a user via, for example, an interface.

In another embodiment of the subject invention, a network filtering device receives an instruction to deploy filtering resources (e.g., of a filtering system, etc.) to filter captured network traffic in a communication network according to at least one criterion. Notably, the instruction is received from a user via an interface (e.g., a graphic user interface) communicatively coupled to the filtering system. The network filtering device further analyzes the received instruction and projects, responsive to the analysis, an amount of filtering resources required to filter the captured traffic according to the received instruction. The network filtering device also provides the projected amount to the user via the interface (e.g., a graph displayed).

In certain embodiments, the network filtering device determines whether the projected amount exceeds a threshold amount of filtering resources. Further still, the network filtering device also provides an alternate filtering instruction to the user responsively to at least one of the analysis of the received instruction and the projection.

In other embodiments, the network filter device further determines an objective of the filtering instruction responsively to the analysis of the received instruction, determines an alternative filtering instruction consistent with the objective, and provides the alternate filtering instruction to the user via the interface.

These and other features of the systems and methods of the subject invention will become more readily apparent to those skilled in the art from the following detailed description of the preferred embodiments taken in conjunction with the drawings.

### BRIEF DESCRIPTION OF THE DRAWINGS

The present application is illustrated by way of example, and not limitation, in the figures of the accompanying drawings, in which:

FIG. 1 is a block diagram depicting a data communications network consistent with an embodiment of the present invention;

FIG. 2 is a block diagram depicting a captured network traffic distribution device consistent with an embodiment of the present invention;

FIG. 3 is a block diagram depicting an exemplary data packet consistent with an embodiment of the present invention; and

FIG. 4 is a flow chart depicting a process for determining allocation of filtering resources for the filtering of captured data packets.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### DESCRIPTION OF EXAMPLE EMBODIMENTS

Described herein are methods, systems and apparatus for determining allocation of filtering resources for the filtering of captured data packets. In one embodiment of the invention, a filtering system (e.g., a captured network traffic distribution device (e.g., a network tap or similar device) or a stacked network of captured network traffic distribution devices in communication with one another) may be configured to receive instructions to deploy filtering resources to filter captured data packets according to at least one criterion or parameter. The instructions may be analyzed and a projected amount of filtering resources required to filter the captured traffic according to the received instruction may be projected and then provided to a user via, for example, an interface.

The analysis and projection may be performed by, or under the direction of, a processor resident in and/or in communication with the filtering system that executes instructions for performing these activities. The instructions may be stored in a computer readable storage medium (e.g., a read-only memory (ROM), erasable programmable read only memory (EPROM), electrically erasable programmable read only memory (EEPROM), random access memory (RAM), flash memory, or other form of storage device) communicatively coupled to the processor.

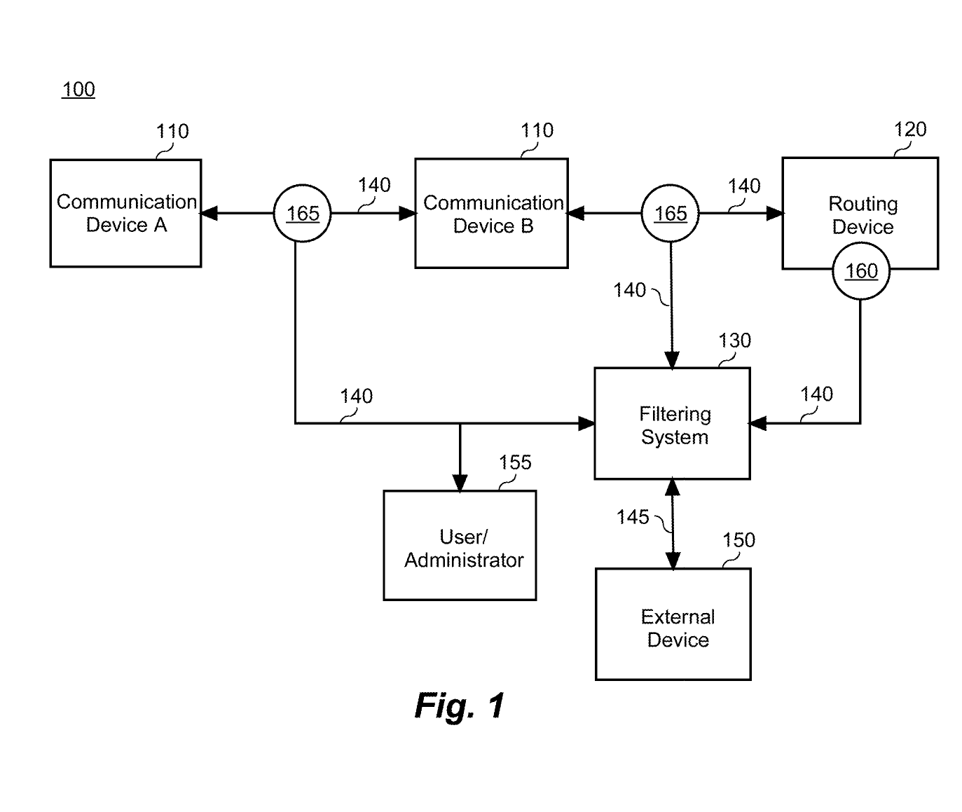

FIG. 1 is block diagram depicting a network communication system 100 in which one or more of the processes disclosed herein may be executed. The components of system 100 may be communicatively coupled via one or more communication links. The communication links may be any conventionally available communication link, such as a wireless link, or a wired link such as an Ethernet cable, a 10/100 Ethernet cable, a 1 gigabit Ethernet cable, a 10 gigabit Ethernet cable, a copper cable, an optical fiber cable, and the like.

System 100 may include two communication devices 110a and 110b communicatively coupled to one another. Exemplary communication devices 110a and 110b include personal computers, mobile computing devices, mobile telephones, computer enabled mobile telephones, etc. Communication device 110a may generate a data packet 140 and transmit data packet 140 to a one or more devices, e.g., a routing device 120, communication device 110b, etc., via one or more communication links. Exemplary data packets 140 include requests to initiate a communication session. Routing device 120 may be any router enabled to route data packets through communication system 100. Communication device 110a may also receive data packet(s) 140 from communication device 110b via a communication link.

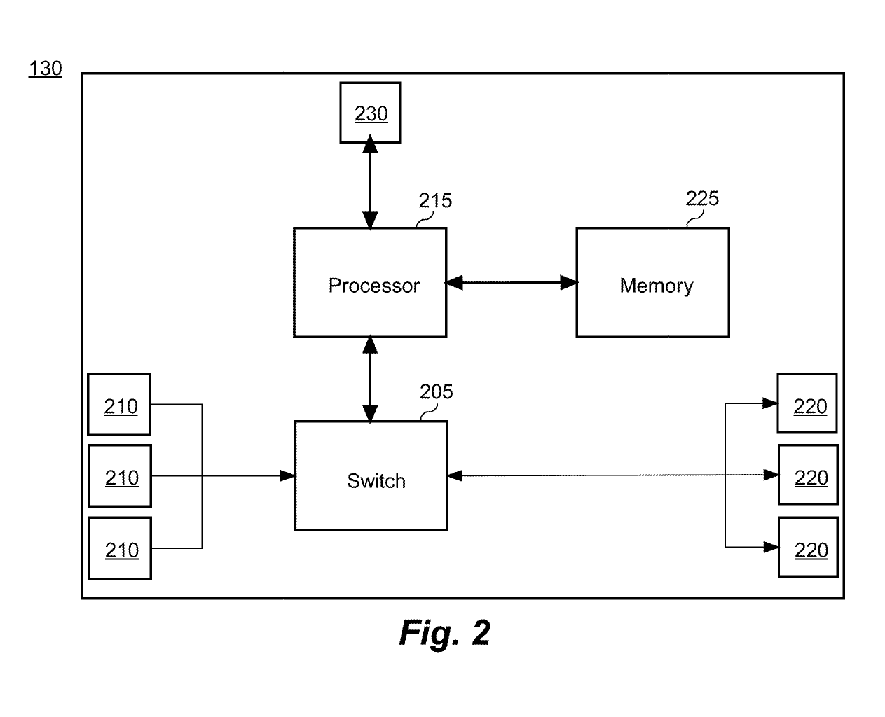

System 100 may also include a filtering system 130, which may be any system capable of receiving and filtering captured network traffic, (e.g., data packets 140). In some embodiments, filtering system 130 may include one or more network captured traffic distribution device(s) (e.g., a network tap or similar device). Filtering system 130 may include a plurality of ports (ref. FIG. 2, discussed below) by which the filtering system may communicate with another device included in system 100 and receive and/or transmit captured traffic. In some cases, a port may be a monitor port or a stacking port. Filtering system 130 may also be communicatively coupled so as to provide information to and/or receive instructions from a user and/or administrator 155. User/administrator 155 may be, for example, a user and/or administrator of, for example, system 100 and/or filtering system 130.

Filtering system 130 may be communicatively coupled to a mirror port 160 present on routing device 120 to receive a traffic flow of captured data packets, including data packet 140, from routing device 120 via mirror port 160. Filtering system 130 may also be communicatively coupled to a traffic capture point 165 located along a communication link between communication device 110a and routing device 120 and/or between communication devices 110a and 110b and thereby may capture data packets, like data packet 140, via an inline network traffic capture point at traffic capture point 165. Filtering system 130 may communicate a modified data packet 145 to an external device 150 via, for example, a port, as discussed below. External device 150 may include multiple input/output ports that may operate in duplex or half-duplex mode. The input/output ports may be associated with configuration information and may be enabled to execute an auto-negotiation process. In some cases, an external port may be a small form-factor pluggable (SFP) port. Exemplary external devices 150 include network monitors and network analyzing devices.

FIG. 2 is a block diagram depicting an exemplary filtering system 130. Filtering system 130 includes a plurality of ingress ports 210 and a plurality of egress ports 220. One or more egress ports 220 may be configured as a monitoring and/or stacking port. Data packets such as data packet 140 may be received by filtering system 130 via one or more ingress ports 210. Data packets may be received from a source of captured traffic, such as a mirror port, like mirror port 160, and/or inline traffic capture point, like inline traffic capture point 165

Received data packets may be forwarded to a switch 205. Switch 205 may be communicatively coupled to ingress ports 210, processor 215, and/or egress ports 220 and may perform a switching function, such as forwarding a data packet received by an ingress port 210 to, for example, processor 215 and/or an egress port 220. In some embodiments, switch 205 may be, for example, an application specific integrated circuit (ASIC) or a field programmable gate array (FPGA).

Processor 215, which is communicatively coupled to switch 205, a memory 225, and/or a management port 230, may be any appropriate processing device, such as a central processing unit (CPU) and/or a FPGA and may execute one or more instructions resident in a memory 225. For example, processor 215 may be enabled to execute one or more of the steps of the processes described herein. Processor 215 may be managed by, for example, a user and/or administrator, like user/administrator 155 via, for example, a management port, like management port 230.

Processor 215 may also be completely self-contained. For example if processor 215 is implemented as a field programmable gate array (FPGA), filtering system 130 may not require the use of external memory 225. In some embodiments, processor 215 and/or switch 205 may filter captured data packets according to one or more instructions received by filtering system 130 and/or resident in memory 225.

Memory 225 may be any appropriate data storage device and may store one or more instructions executable by processor 215, and/or switch 205. Memory 225 may be any appropriate data storage device, like static random access memory (SRAM), dynamic random access memory (DRAM), read-only memory (ROM), flash memory, a magnetic computer storage device (e.g. hard disk, floppy disk, and magnetic tape), and optical media and may store one or more instructions executable by processor 215 and/or switch 205.

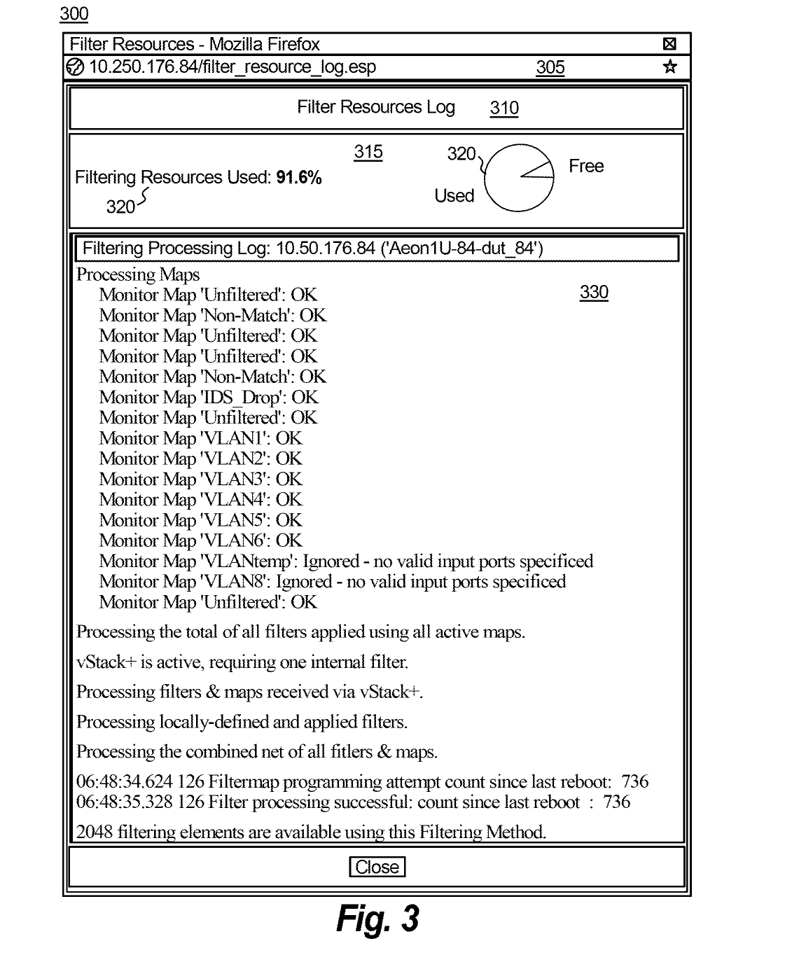

FIG. 3 is a screen shot of an exemplary interface 300 presented to a user that indicates the allocation of filtering resources for the filtering of captured data packets. Interface 300 may be accessed by the user via a network, such as the Internet, via a URL or web address 305. Interface 300 may include a filter resource log 310 that includes a filter allocation window 315. Filter allocation window 315 may include one or more indicators 320 of filtration allocation or projected filtration allocation. Exemplary indicators include text (e.g., filtering resources used: 91.6%), a picture, and a graph. Interface 300 may also include one or more filtering instructions or protocols as displayed in a filtering processing log 330.

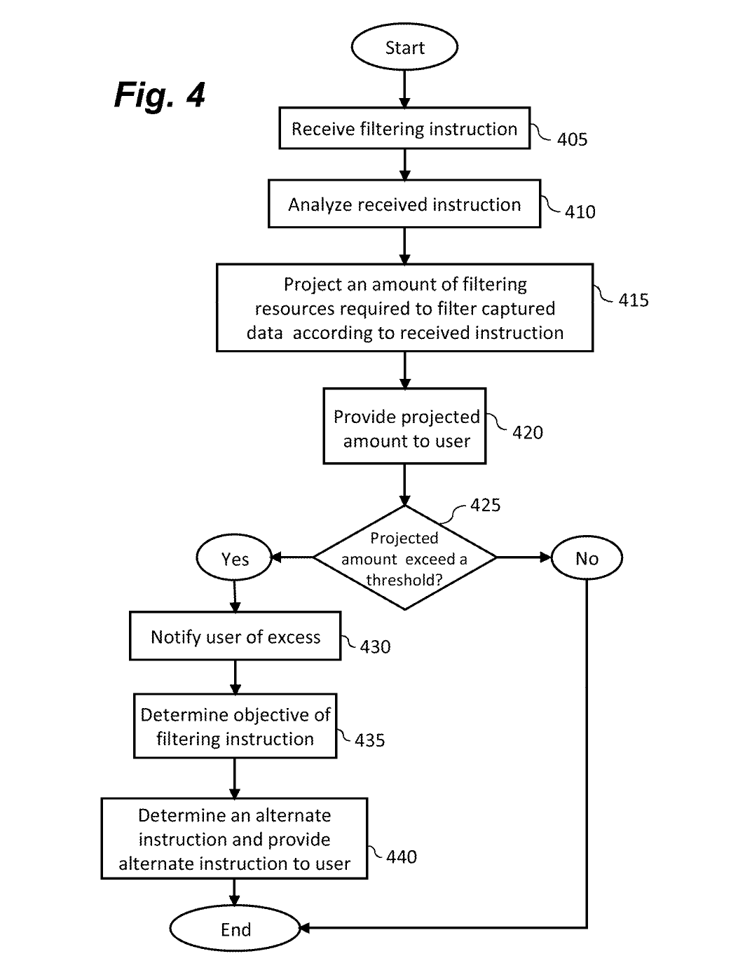

FIG. 4 illustrates an exemplary process 400 for providing feedback to a user regarding an amount of filtering resources required to filter the captured traffic according to a received instruction. Process 400 may be executed by, for example, any of the systems or system components disclosed herein.

In step 405, an instruction to deploy filtering resources of a filtering system

such that the filtering system filters captured network traffic according to at least one criterion may be received from a user. The instructions may be received via an interface, such as interface 300, communicatively coupled to the filtering system.

The received instruction may then be analyzed (step 410) and an amount of filtering resources required to filter the captured traffic according to the received instruction may be projected responsively to the analysis (step 415) and provided to the user (step 420). The projected filtering resource consumption may be provided to the user via any appropriate medium including, but not limited to, a percentage of filtering resources consumed when the instruction is executed, a percentage of filtering resources remaining unused when the instruction is executed, a graph (e.g., bar graph, line graph), a table, and/or a chart (e.g., pie chart).

On some occasions, it may be determined whether the projected amount of resource consumption exceeds a threshold amount of filtering resources (step 425). When the threshold is exceeded, a notice of the excess may be provided to the user via, for example, the interface (step 430). On some occasions, a recommendation or alternate filtering instruction may be provided to the user when the projected amount of resource consumption exceeds the threshold.

Optionally, an objective of the filtering instruction may be determined (step 435) and, on some occasions, an alternative instruction and/or process consistent with the objective may be determined (step 445). The alternative instruction may be, for example, more efficient at achieving the objective (e.g., executes more quickly, load balances filtering across multiple filtering devices, and/or requires reduced processing time) than the received instruction. For example, when the instruction indicates that captured data packets that include data matching a first and second criteria but not a third criteria are to be transmitted to a particular egress port may be more efficiently implemented by rearranging the filtering sequence (e.g., filtering out all captured data packets that do not include data matching the third criteria and then filtering for data packets that do include data matching the first and second criteria), the alternate instruction may be provided to the user via the interface (step 450) and process 400 may end.

In the preceding discussion various embodiments of the present invention were described as being implemented with the aid of computer-implemented processes or methods (a.k.a. programs or routines). Such programs may be rendered in any computer-readable language and, in general, are meant to encompass any series of logical steps performed in a sequence to accomplish the stated purpose. Any part of the foregoing description that was presented in terms of algorithms and/or symbolic representations of operations on data within a computer memory should be understood as steps requiring physical manipulations of physical quantities (usually represented in the form of electrical or magnetic signals) within computer-readable storage devices. Accordingly, throughout the preceding description of the present invention, terms such as “processing”, “computing”, “calculating”, “determining”, “displaying” or the like, should be understood as referring to the actions and processes of an appropriately programmed computer processor, or similar electronic device, that manipulates and transforms data represented as physical (electronic) quantities within the computer processor's registers and any associated memories or other storage devices into other data similarly represented as physical quantities within those memories or registers or other such information storage devices. The programs comprise computer-executable instructions stored on one or more such computer-readable storage mediums accessible to the computer processor, for example any type of disk including hard disks, floppy disks, optical disks, compact disk read only memories (CD-ROMs), and magnetic-optical disks, ROMs, RAMs, EPROMs, EEPROMs, flash memories, or other forms of storage media accessible to the computer processor.

What is claimed is:

1. A method executed by a computerized filtering system, the method comprising:
receiving an instruction to deploy filtering resources of the computerized filtering system to filter captured network traffic in a communication network according to at least one criterion, wherein the instruction is received from a user via an interface communicatively coupled to the filtering system;
analyzing the received instruction;
projecting an amount of filtering resources required to filter the captured traffic according to the received instruction responsively to the analysis of the received instruction; and
providing the projected amount to the user via the interface.

2. The method of claim 1, further comprising:
determining whether the projected amount exceeds a threshold amount of filtering resources.

3. The method of claim 1, further comprising:
providing an alternate filtering instruction to the user responsively to at least one of the analysis of the received instruction and the projection.

4. The method of claim 1, further comprising:
determining an objective of the filtering instruction responsively to the analysis of the received instruction;
determining an alternative filtering instruction consistent with the objective; and
providing the alternate filtering instruction to the user via the interface.

5. The method of claim 1, wherein the interface is a graphic user interface and the projected amount is provided to the user via a graph displayed on the graphic user interface.

6. An apparatus for filtering data packets in a communication network, comprising:
one or more network interfaces adapted to communicate in the communication network;
a processor adapted to execute one or more processes; and
a memory configured to store a process executable by the processor, the process when executed operable to:
receive an instruction to deploy filtering resources to filter captured network traffic in the communication network according to at least one criterion;
analyze the received instruction;
project an amount of filtering resources required to filter the captured traffic according to the received instruction responsively to the analysis of the received instruction; and
provide the projected amount to the user via the interface.

7. The apparatus of claim 6, wherein the process when executed is operable to:
determine whether the projected amount exceeds a threshold amount of filtering resources.

8. The apparatus of claim 6, wherein the process when executed is operable to:
provide an alternate filtering instruction to a user responsively to at least one of the analysis of the received instruction and the projection.

9. The apparatus of claim 6, wherein the process when executed is operable to:
determine an objective of the filtering instruction responsively to the analysis of the received instruction;
determine an alternative filtering instruction consistent with the objective; and
provide the alternate filtering instruction to the user via the interface.

10. The apparatus of claim 6, wherein the projected amount is provided to a user via a graph displayed on a graphic user interface.

11. A tangible, non-transitory, computer-readable media of a computerized filtering system having software encoded thereon, the software, when executed by a processor, operable to:
receive an instruction to deploy filtering resources of a computerized filtering system to filter captured network traffic in a communication network according to at least one criterion, wherein the instruction is received from a user via an interface communicatively coupled to the filtering system;
analyze the received instruction;
project an amount of filtering resources required to filter the captured traffic according to the received instruction responsively to the analysis of the received instruction; and
provide the projected amount to the user via the interface.

12. The tangible, non-transitory, computer-readable media of claim 11, wherein the software, when executed, further operable to:
determine whether the projected amount exceeds a threshold amount of filtering resources.

13. The tangible, non-transitory, computer-readable media of claim 11, wherein the software, when executed, further operable to:
provide an alternate filtering instruction to the user responsively to at least one of the analysis of the received instruction and the projection.

14. The tangible, non-transitory, computer-readable media of claim 11, wherein the software, when executed, further operable to:
determine an objective of the filtering instruction responsively to the analysis of the received instruction;
determine an alternative filtering instruction consistent with the objective; and
provide the alternate filtering instruction to the user via the interface.

15. The tangible, non-transitory, computer-readable media of claim 11, wherein the interface is a graphic user interface and the projected amount is provided to the user via a graph displayed on the graphic user interface.
